(19) United States
(12) Patent Application Publication
(10) Pub. No.: US 2005/0171916 A1
(43) Pub. Date: Aug. 4, 2005

(54) Application program interface for postal security device

(76) Inventor: James M. Mattern, Bethany, CT (US)

Correspondence Address: PERMAN & GREEN, 425 POST ROAD, FAIRFIELD, CT, 06824, US

(21) Appl. No.: 10/768,898

(22) Filed: Jan. 30, 2004

(51) Int. Cl. H04K 1/00

(52) U.S. Cl. 705/60; 713/200; 705/64; 705/67; 705/62

(57) ABSTRACT

An application program interface for controlling one or more postal security devices (PSD's) includes a function for configuring COM ports of the one or more PSD's, a function for initializing the one or more PSD's, a function for logging in to the one or more PSD's using PIN numbers, a function for enabling funds management, and a function for activating or suspending indicia printing.

### BACKGROUND

1. Field of the Invention

The present to postal security devices and, more particularly, to an application program interface for controlling postal security devices.

2. Brief Description of Related Developments

In general, postal security devices (PSD's) are controlled by complex software. It would be advantageous to provide a high level interface between one or more PSD's and an application developer.

### SUMMARY OF THE INVENTION

The present invention is directed to an application program interface for controlling one or more postal security. devices (PSD's). The API includes a function for configuring COM ports of the one or more PSD's, a function for initializing the one or more PSD's, a function for logging in to the one or more PSD's using PIN numbers, a function for enabling funds management, and a function for activating or suspending indicia printing.

### BRIEF DESCRIPTION OF THE DRAWINGS

The foregoing aspects and other features of the present invention are explained in the following description, taken in connection with the accompanying drawings, wherein:

FIG. 1 shows an example of how a web developer would create indicia;

FIG. 2 shows a system according to the present invention and the general operations provided by an API incorporating features of the present invention;

FIG. 3 shows an example of a funds download function; and

FIGS. 4-13 show examples of screens and functions presented by the API to a user.

### DETAILED DESCRIPTION OF THE PREFERRED EMBODIMENT(S)

Although the present invention will be described with reference to the embodiment shown in the drawings, it should be understood that the present invention can be embodied in many alternate forms of embodiments. In addition, any suitable size, shape or type of elements or materials could be used.

The present invention is directed to a high level application program interface (API) that provides low level communication between one or more PSD's, also referred to as SAFE's, and an application developer. In another embodiment, the present invention also provides low level communication between a PSD and a service provider infrastructure.

The present invention is compatible with a variety of development environments such as web pages, for example, Active Server Pages or complied languages for example, Visual C++ or Visual Basic. The process of creating indicia is the same generally across environments but the means of extrapolating data may be different. A developer gathers rate information, recipient address, etc. then submits this information to a PSD through the present invention, which validates the incoming data, creates an indicia stream, and returns that stream to the developer. The developer can then return that stream to a client and create an image on the client's computer or create the image on a server and return the image to the client.

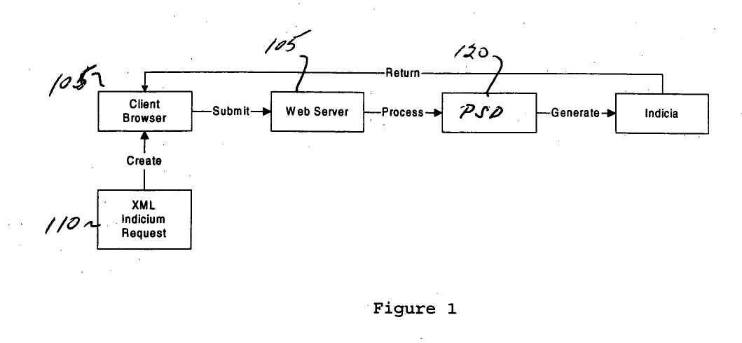

An example of how a web developer would create indicia is shown in FIG. 1. A user browses a web page and selects a postage generating service 105. Selection of this service constructs an XML indicia request l10 and submits the request to a Web Server 115. The Web Server 115 processes the XML request, and submits it to a PSD, also referred to as a SAFE 120. The SAFE 120 generates indicia 125, which is returned to the user through the browser 105.

The primary components of the API of the present invention are:

An image maker routine, or program, which may be a Common Object Model (COM) Dynamic Link Library (DLL) built on an Active Template Library (ATL). The image maker routine is generally installed a client or server and operates to convert the indicia into a JPEG or Bitmap file image for printing;

A control program, which may be a COM service built on ATL to be used exclusively by a server. This control program maintains and regulates the activities of the one or more PSD's. The activities may generally include indicia creation, postage download, and server configuration; and

A PSD Agent which is a program that may be a COM component built on ATL and may be used exclusively by the control program to service a number of PSD's. The PSD Agent may not be directly accessible by a developer.

The API generally provides the following functions:

An indicia creation interface which controls the implementation process of creating indicia that represents postage and a system of payment; Indicia creation rates may be in excess of 18,000 per hour;

A payment process that includes downloading funds into the PSD's from a service provider's infrastructure for indicia printing;

Remote access configuration which may includes specifying a RAS phonebook connection or a network card, and specifying port and IP address of a service provider's server;

A configuration function that includes computer selection, adding and specifying communication ports, and activating or deactivating PSD's by use of a Personal Identification Number (PIN) logon;

Automated download configuration that enables or disables automated downloads and threshold amounts;

A first time download function that provides an initial funds download to prime a PSD for indicia printing;

A maintenance function that provides a connection to a service provider infrastructure for automated software upgrades, resetting of timers, etc.;

A refund process for removing a PSD from operations and refunding any remaining postage contained by the PSD. This operation renders the PSD inoperable;

An information display providing a visual representation of the PSD's condition, including funds available, descending and ascending registers, battery expiration, etc.; and

Log facilities that provide three different levels log tracing: event tracing, event logging and error tracking.

In order to begin operations, a supervisor or supervisory function must configure a set of COM ports to communicate with the PSD's before operations are started. An account on the service provider infrastructure for downloading funds for each PSD is generally established. The supervisory function generally provides individual PIN numbers for each PSD, a PSD will generally not store these values will require them each time the PSD is logged onto. An automated funds download threshold is usually supplied before operations are started.

The API may be implemented using COM and may support languages such as Visual C++, Visual Basic and Active Server Pages (ASP).

The API may control PSD's across a distributed system, for example the API may reside on one system, while a number of PSD's under control of the API may reside on another system connected by a network.

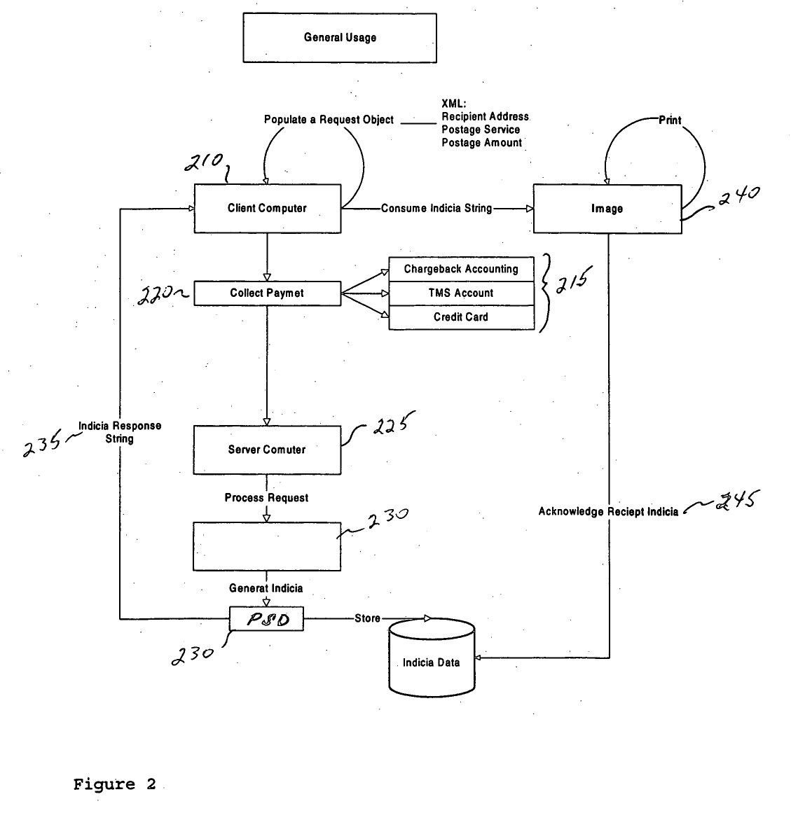

FIG. 2 shows a system according to the present invention and the general operations provided by an API incorporating features of the present invention. A user provides information such as an address, type of service, and postage amount through client computer 210. A method of payment is selected 215 and a payment is collected 220. A server 225 controlling one or more PSD's 230 processes an indicia request through an interface 230 to a PSD 230. An indicia byte stream or image 235 is sent to the client computer 210 and the image is printed. 240. An acknowledgement that the image has been printed 245 is stored for recording purposes.

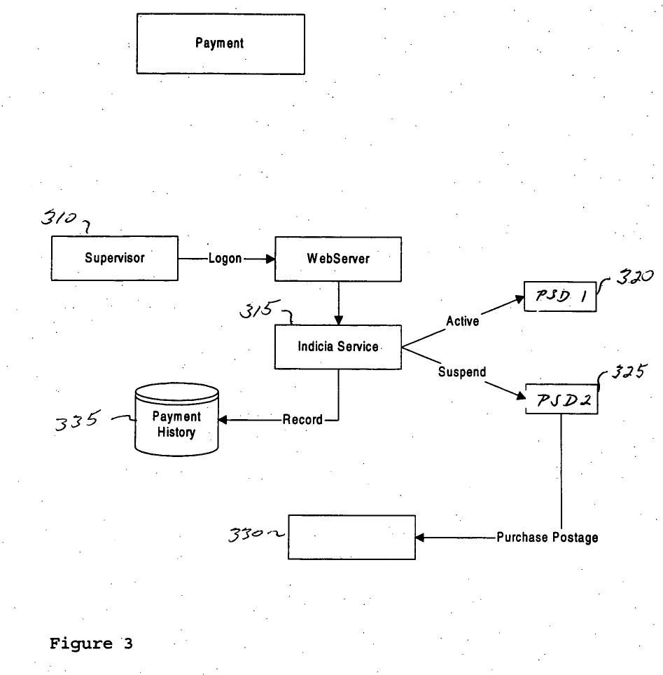

In addition to general operations, the API also provides for funds downloading in the event that a PSD runs low on funds. Funds download is an automated function that may be set by the supervisor. An example of a funds download function is shown in FIG. 3. A supervisor 310 configures funds downloading. through an indicia service routine 315, including setting a funding threshold for a number of PSD's 320, 325. When a PSD 325 reaches the threshold, the indicia service routine 315 suspends operations for the PSD 325 and starts and automated funds download from a service provider 330. Upon a successful funds download, the indicia service routine 315 updates a download history 335.

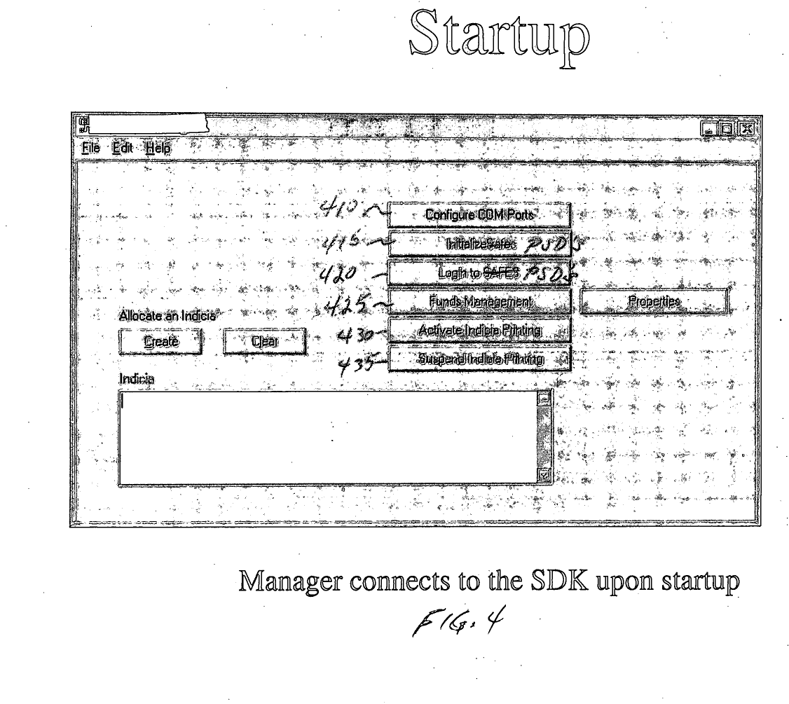

Detailed operations and examples of screens presented to a user as part of the API will now be explained. On startup of the API, the user is presented with a screen as shown in FIG. 4. The API provides a user with the ability to configure COM ports for the PSD's 410, initialize the PSD's 415, login to the PSD's, 420 enable funds management 425, and activate or suspend indicia printing 430, 435. While the functions provided by selections 415, 420, 425, 430, and 435 are as stated,. the nomenclature indicated in selections 415, 420, 425, 430, and 435 is exemplary and other nomenclature may be used to indicate the functions performed.

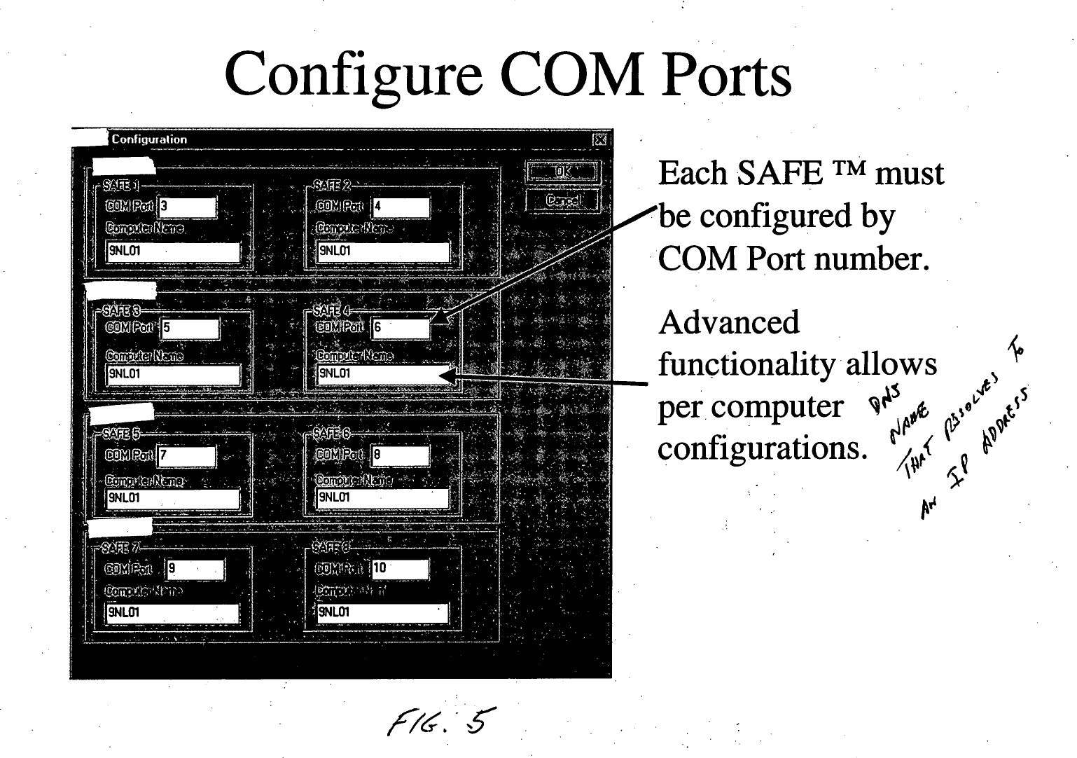

FIG. 5 shows a screen for configuring the COM ports of the PSD's accessed by selecting Configure COM Ports 410. The screen provides an entry for a COM port number and computer name for each PSD.

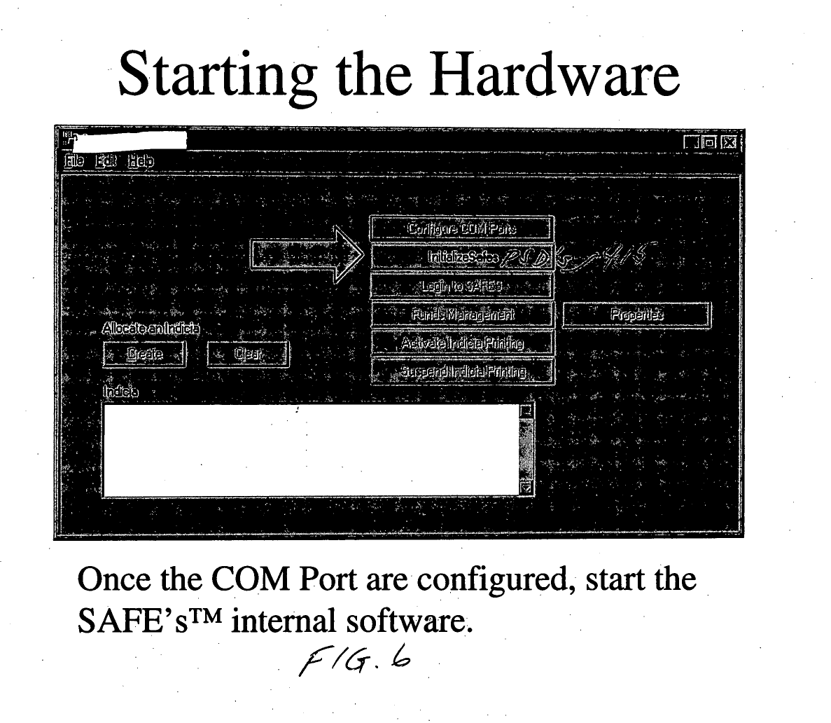

Once the COM ports for each PSD have been set up, the PSD's are initialized by the Initialize PSD's selection 415 as shown in FIG. 6.

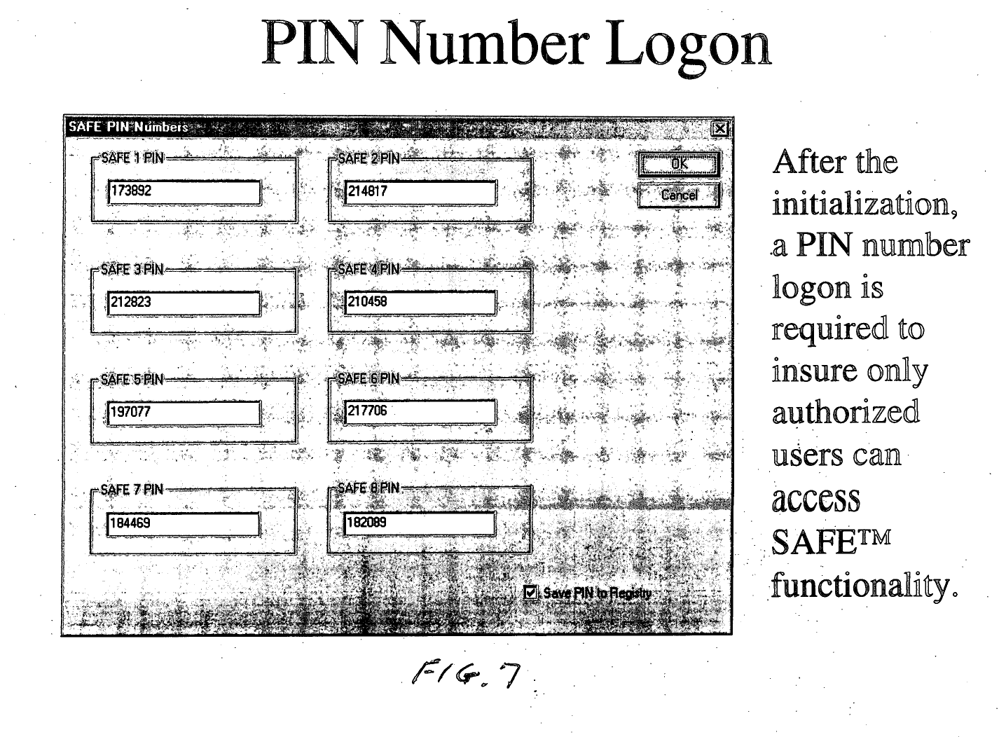

After initialization, selecting Login to PSD's 420 provides a user with the ability to perform a PIN number logon for each PSD as shown in FIG. 7.

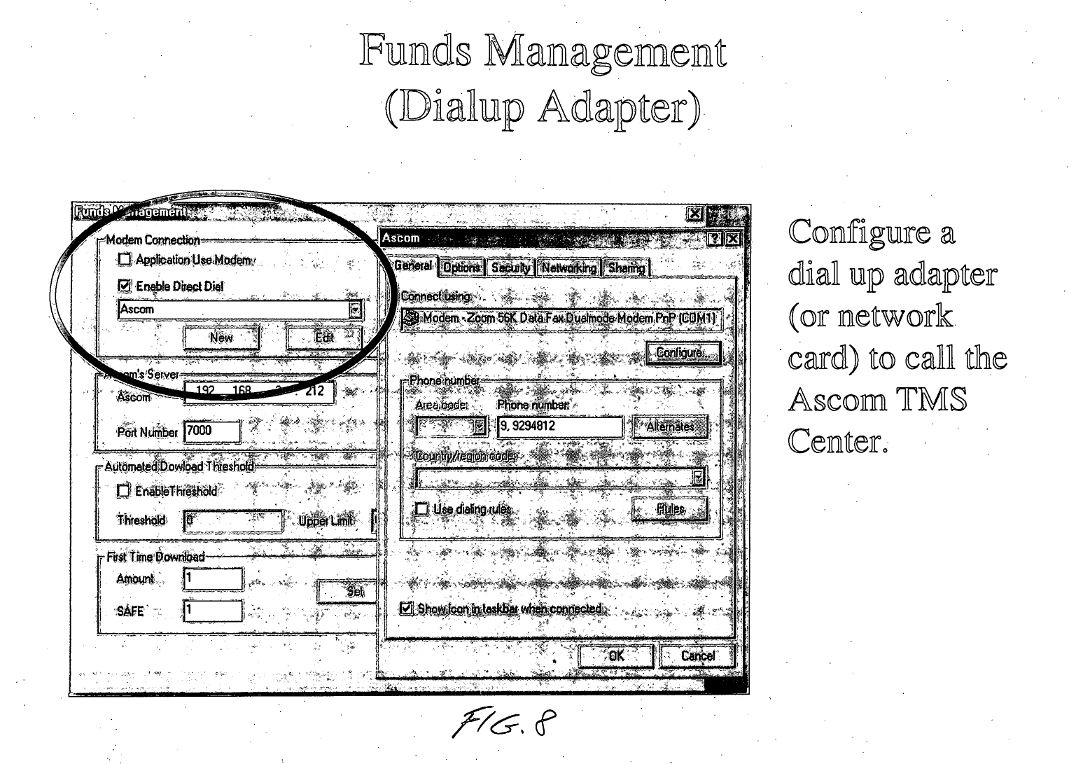

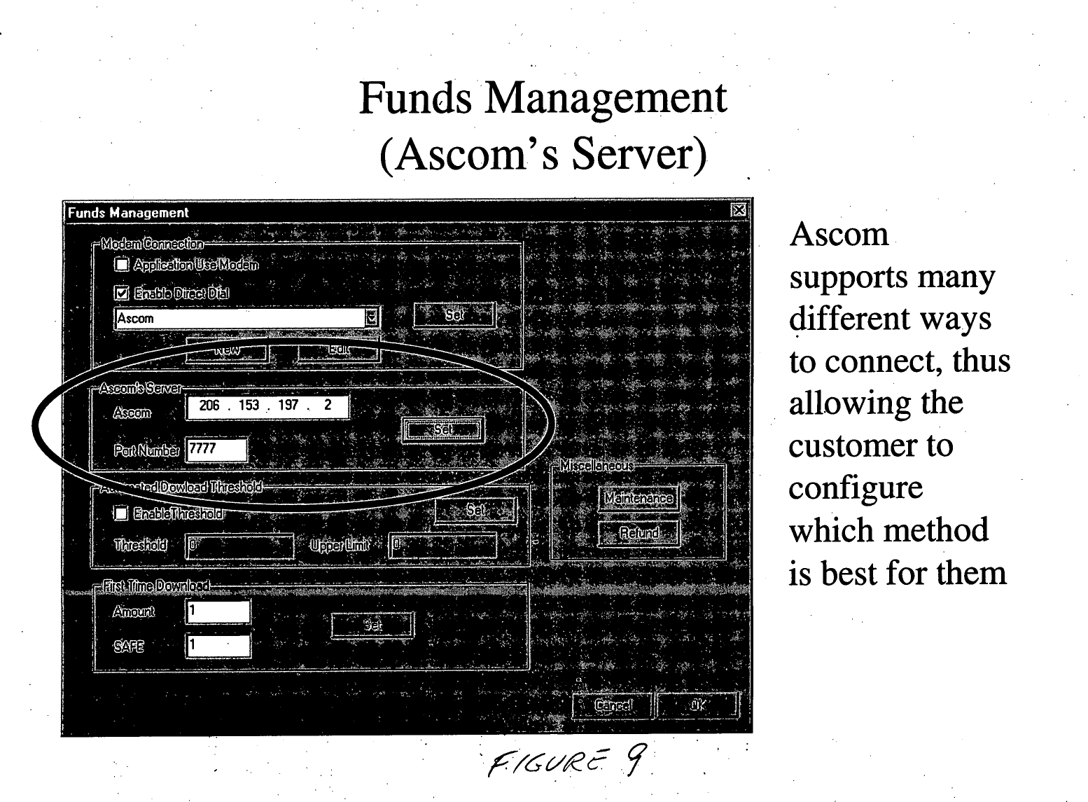

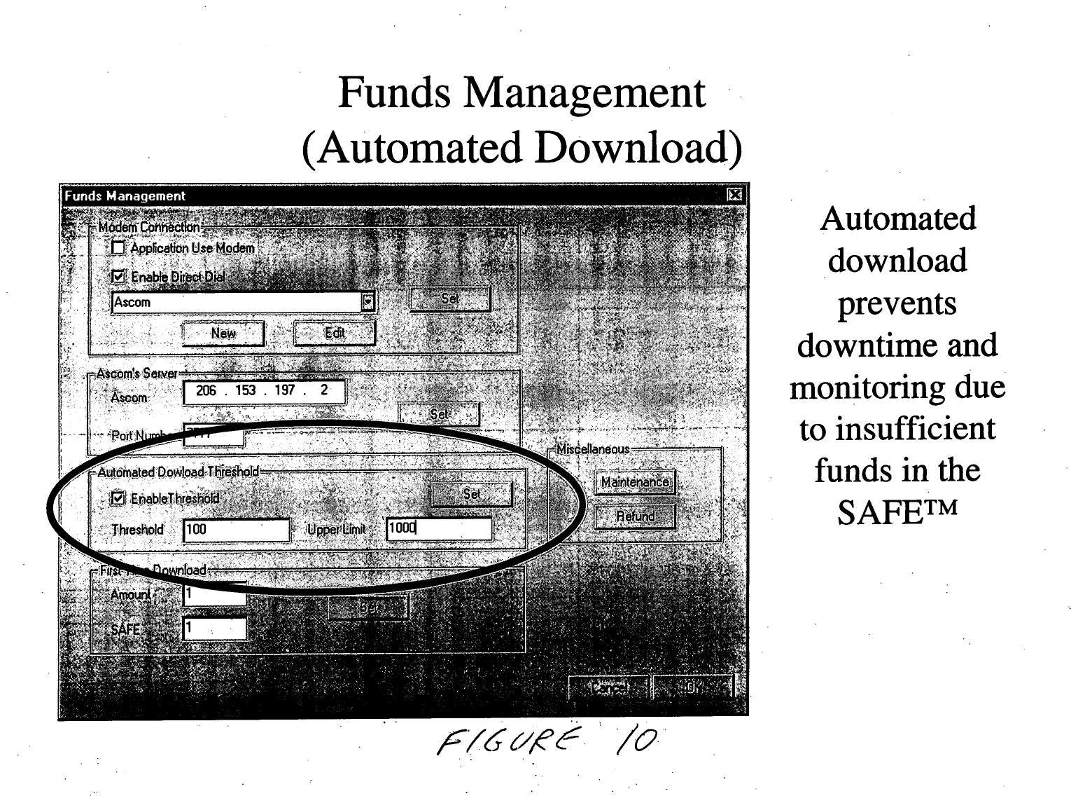

Selecting Funds Management 425 provides a user with a screen as shown in FIG. 8, where a dial up adapter may be configured to call a service provider infrastructure. Alternately, a network card may be configured as shown in FIG. 9. An automatic download threshold may also be specified for the PSD's as shown in FIG. 10.

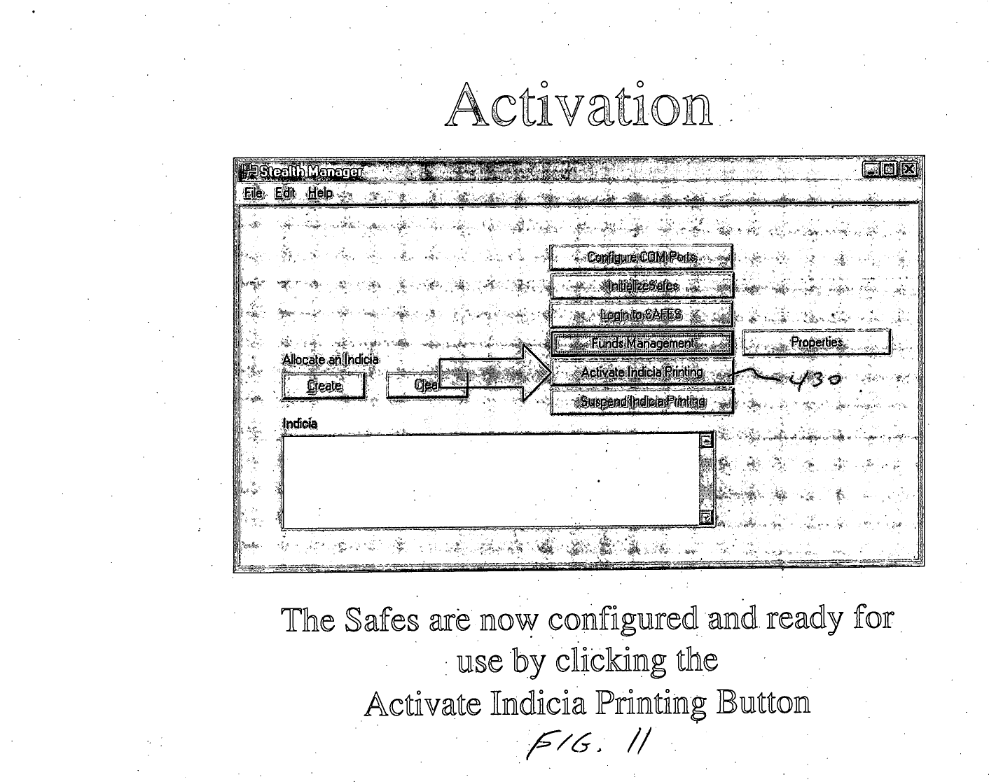

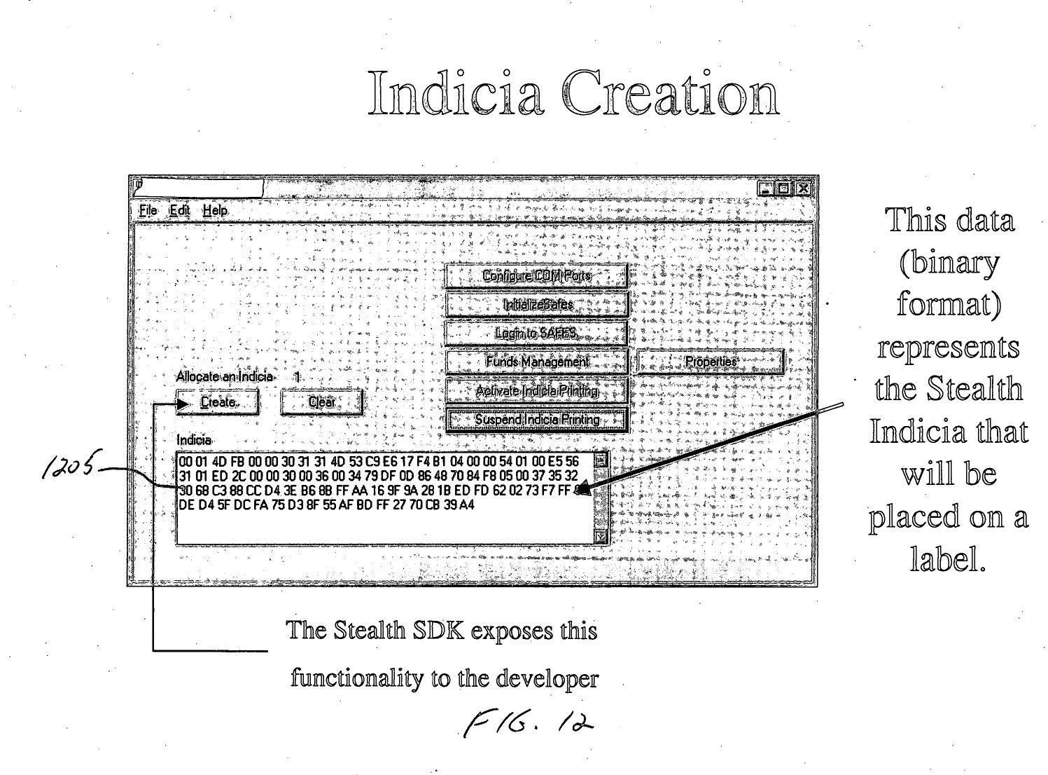

Once the PSD's have been configured, they may be put into use by selecting Activate Indicia Printing 430 as shown in FIG. 11. As a PSD creates indicia, an indicia string 1205 is displayed for a user as shown in FIG. 12.

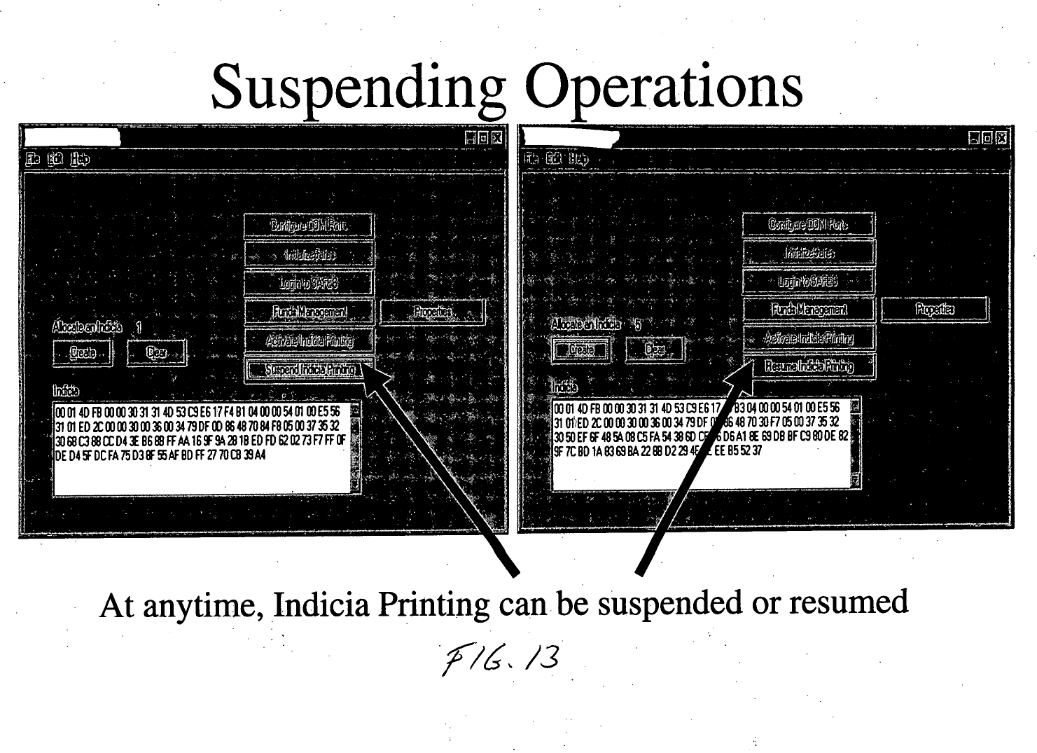

At anytime, indicia printing may be suspended or resumed by selecting Suspend Indicia Printing or Resume Indicia Printing as shown in FIG. 13.

Thus, the present invention provides a high level API that is intuitive and easy to use when utilizing one or more PSD's for printing indicia. The interface also provides a communication path between the PSD's and a service provider for funds replenishment.

It should be understood that the foregoing description is only illustrative of the invention. Various alternatives and modifications can be devised by those skilled in the art without departing from the invention. Accordingly, the present invention is intended to embrace all such alternatives, modifications and variances.

1. An application program interface (API) for controlling one or more postal security devices (psd's), comprising:
a function for configuring COM ports of the one or more PSD's;
a function for initializing the one or more PSD's;
a function for logging in to the one or more PSD's using PIN numbers;
a function for enabling funds management; and
a function for activating or suspending indicia printing.

2. The API of claim 1, wherein the function for configuring COM ports comprises a facility for specifying a COM port and a computer name for each of the one or more PSD's.

3. The API of claim 1, wherein the function for initializing the one or more PSD's starts the internal software of the one or more PSD's.

4. The API of claim 1, wherein the function for enabling funds management allows a programmer to configure a dial up adapter for communication with a service provider infrastructure.

5. The API of claim 1, wherein the function for enabling funds management allows a programmer to configure a network interface for communication with a service provider infrastructure.

6. The API of claim 1, wherein the function for enabling funds management allows a programmer to set an automatic download threshold.

7. The API of claim 1, wherein the function for activating or suspending indicia printing displays an indicia string as an individual PSD of the one or more PSD's creates indicia.

8. An application program interface (API) for one or more postal security devices (PSD's), comprising:
a control program to maintain and regulate the activities of the one or more PSD's;
a PSD agent used exclusively by the control program to service the one or more PSD's; and
an image maker routine that operates to convert indicia into an image file for printing by the one or more PSD's.

9. The API of claim 8, wherein the activities controlled and maintained by the control program include indicia creation, postage download, and server configuration.

10. The API of claim 8, wherein the PSD agent is not directly accessible by a developer.

11. The API of claim 8, wherein the image maker routine is a dynamic link library.

12. The API of claim 8, wherein the image file is a JPEG file.

13. The API of claim 8, wherein the image file is a bitmap file.
